(19) United States
(12) Patent Application Publication
(10) Pub. No.: US 2014/0205399 A1
(43) Pub. Date: Jul. 24, 2014

(54) AUTOMATIC STORAGE RACK

(71) Applicants: Keita Sato, Inuyama-shi (JP); Osamu Fukuta, Inuyama-shi (JP); Takahiro Kanbe, Inuyama-shi (JP)

(72) Inventors: Keita Sato, Inuyama-shi (JP); Osamu Fukuta, Inuyama-shi (JP); Takahiro Kanbe, Inuyama-shi (JP)

(73) Assignee: MURATA MACHINERY, LTD., Kyoto-shi, Kyoto (JP)

(21) Appl. No.: 14/237,386

(22) PCT Filed: Jun. 19, 2012
(86) PCT No.: PCT/JP2012/065587

§ 371 Date: Feb. 6, 2014

(30) Foreign Application Priority Data
Aug. 10, 2011 (JP) 2011-174713

(51) Int. Cl. B65G 1/02

(52) U.S. Cl. CPC B65G 1/02
USPC 414/267

(57) ABSTRACT

An automatic storage rack is arranged along a route for a stacker crane. The automatic storage rack includes a rack apparatus body, and a plurality of shelves provided in the rack apparatus body. At least one of the shelves includes a base member fixed to the rack apparatus body, a placement member, and a height changing mechanism. The placement member is arranged to have an article placed thereon. The placement member is attached to the base member such that the placement member is movable relative to the placement member. The height changing mechanism is configured to change a height of the placement member relative to the base member when the placement member moves relative to the base member back and forth.

### BACKGROUND OF THE INVENTION

1. Field of the Invention

The present invention relates to a rack, and in particular to an automatic storage rack positioned along a route of a stacker crane.

2. Description of the Related Art

An automatic storage includes racks positioned along the route of the stacker crane. The rack includes a main body portion having a plurality of support posts arranged along the route, and a plurality of shelves arranged in the main body portion. The support posts include first support posts arranged close to the route and second support posts arranged apart from the route. Each of the first support posts and each of the second support posts correspond to each other so as to constitute a pair and are arranged with a space in between. The shelves receive articles. The plurality of shelves are vertically arranged with spaces in between, with respect to the pair of the first support post and the second support post. There is known a rack equipped with stoppers for preventing articles from falling to the route side of the shelves (see, for example, JP-A-11-208830).

In the conventional rack, the stoppers are attached to the route side of the shelves by welding or with screws. Thus, even if the rack sways sideways due to occurrence of an earthquake or the like, the articles are stopped by the stopper so that the articles hardly fall from the shelves.

In the conventional rack, articles that move when the rack sways sideways make contact with the stoppers and are stopped by the same. Therefore, there is a possibility that the articles might be damaged when the articles contact with the stoppers.

### SUMMARY OF THE INVENTION

Preferred embodiments of the present invention prevent articles from falling even if a rack sways sideways.

According to a first preferred embodiment of the present invention, an automatic storage rack is arranged along a route for a stacker crane. The automatic storage rack includes a main body, and a plurality of shelves provided in the main body. At least one of the shelves includes a base member fixed to the main body, a placement member, and a height changing mechanism. The placement member is arranged such that an article is placed thereon. The placement member is attached to the base member such that the placement member is movable relative to the base member. The height changing mechanism is configured to change a height of the placement member relative to the base member when the placement member moves in a horizontal direction relative to the base member.

In this rack, when the rack sways sideways and the placement member, on which the articles are placed, moves horizontally relative to the base member due to an external force of the side sway, the height of the placement member relative to the base member is changed. Thus, kinetic energy (external force) that moves the placement member horizontally is converted into potential energy, so that only a portion of the external force acts on the articles. Therefore, even if the rack sways sideways, the articles hardly fall.

The height changing mechanism may be configured to change the height of the placement member relative to the base member when the placement member moves relative to the base member in a first horizontal direction perpendicular or substantially perpendicular to the route. Thus, the articles hardly fall to the route side on which the stacker crane is positioned.

The height changing mechanism may cause heights of two ends of the placement member in the first horizontal direction to be different from each other. Thus, since the heights of both ends of the placement member in the first horizontal direction are changed when the placement member moves in the first horizontal direction, the placement member easily returns to the position before movement.

The base member and the placement member may be elongated in the first horizontal direction. One of the base member and the placement member may be provided with a concave portion extending in the first horizontal direction. The other of the base member and the placement member may be provided in the concave portion and separated from the concave portion by a gap in a height direction. Thus, even if the height changing mechanism is arranged between the base member and the placement member, the entire height is reduced.

The height changing mechanism may include two pins provided respectively at two ends of the base member in the first horizontal direction, and two slits arranged respectively at two ends of the placement member in the first horizontal direction and into which the two pins are inserted, respectively. Thus, the height changing mechanism is less expensive.

Each of the slits may include a first portion extending in the first horizontal direction and a second portion extending to the inward and downward from the first portion. Thus, the height is changed by a simple slit shape.

Each of the slits may extend obliquely downward toward the other slit. In this case, slits may have the shape of an arc projecting downward. In addition, the slits may include a first portion extending obliquely downward toward the other slit and a second portion extending in the first horizontal direction from the first portion.

Each of the slits may be V-shaped or substantially V-shaped and include a first portion and a second portion. In this case, the first portion and the second portion each may have the shape of a straight line. In addition, each of the first portion and the second portion may include a first straight portion and a second straight portion connected to an upper end of the first straight portion. An angle of the second straight portion relative to the first horizontal direction may be larger than an angle of the first straight portion relative to the first horizontal direction.

According to various preferred embodiments of the present invention, kinetic energy (external force) that moves the placement member horizontally is converted into potential energy, so that only a part of the external force acts on the articles. Therefore, even if the rack sways sideways, movement amounts of the articles are significantly decreased. As a result, the articles hardly fall.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic side view of an automatic storage that adopts a first preferred embodiment of the present invention.

FIG. 2 is a schematic plan view of the automatic storage.

FIG. 3 is a front view of shelves.

FIG. 4 is a side view of the shelves.

FIG. 5 is a perspective view of the shelves.

FIG. 6 is an XI-XI cross-sectional view of the shelves.

FIG. 7A is a side view illustrating a height changing operation when the shelves sway sideways.

FIG. 7B is a side view illustrating the height changing operation when the shelves sway sideways.

FIG. 7C is a side view illustrating the height changing operation when the shelves sway sideways.

FIG. 8A is a diagram corresponding to FIG. 6 illustrating a first variation of the shelves of the first preferred embodiment of the present invention.

FIG. 8B is a diagram corresponding to FIG. 6 illustrating the first variation of the shelves of the first preferred embodiment of the present invention.

FIG. 9A is a diagram corresponding to FIG. 6 illustrating shelves of a second variation of the first preferred embodiment of the present invention.

FIG. 9B is a diagram corresponding to FIG. 6 illustrating the shelves of the second variation of the first preferred embodiment of the present invention.

FIG. 10A is a diagram corresponding to FIG. 6 illustrating shelves of a second preferred embodiment of the present invention.

FIG. 10B is a diagram corresponding to FIG. 6 illustrating the shelves of the second preferred embodiment of the present invention.

FIG. 11A is a diagram corresponding to FIG. 6 illustrating shelves of a variation of the second preferred embodiment of the present invention.

FIG. 11B is a diagram corresponding to FIG. 6 illustrating the shelves of a variation of the second preferred embodiment of the present invention.

### DETAILED DESCRIPTION OF THE PREFERRED EMBODIMENTS

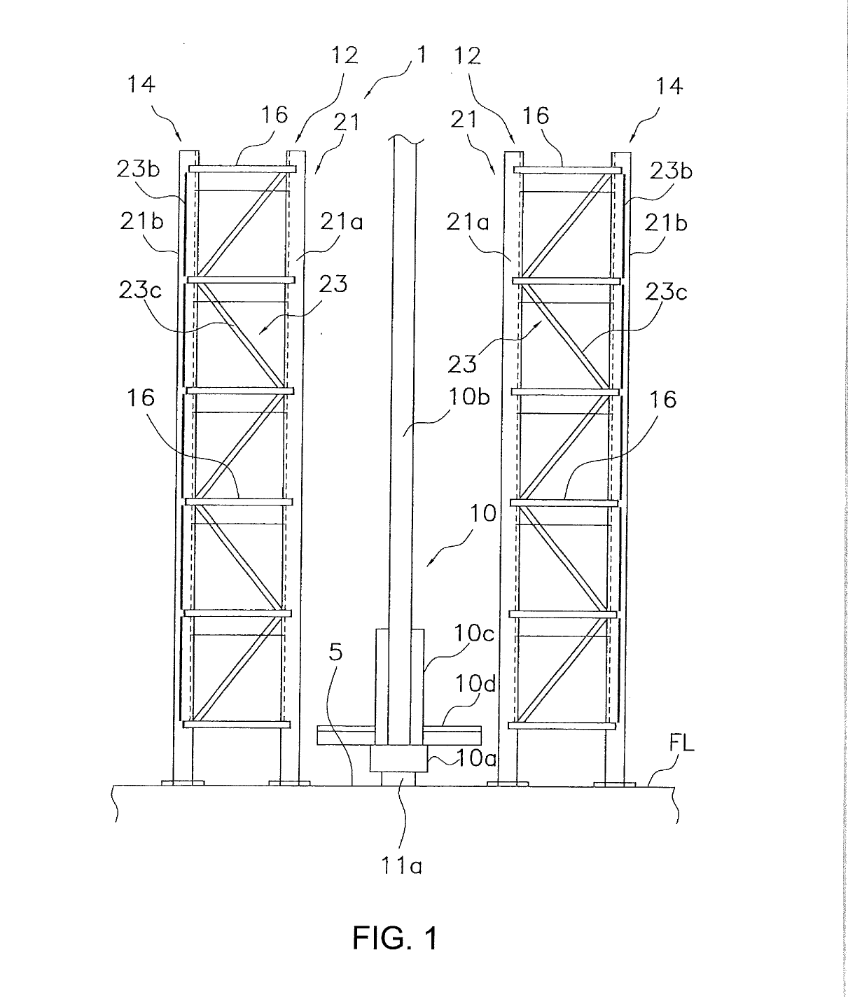

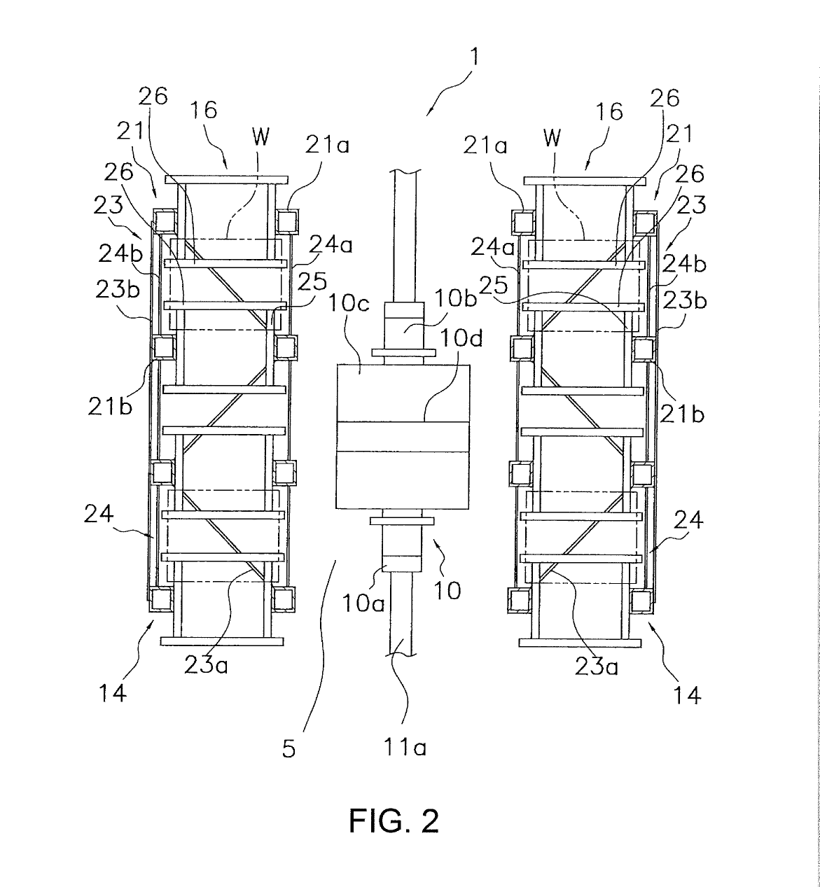

FIG. 1 is a side view of an automatic storage 1 viewed in a route direction of a stacker crane 10. FIG. 2 is a plan view of the automatic storage 1 viewed from above.

Note that a direction of a route 5 (travel direction) of the stacker crane 10 corresponds to the up and down direction of FIG. 2. In addition, a direction in which the stacker crane 10 is leaving from the route 5 (back and forth direction, depth direction) corresponds to the right and left direction of FIG. 1.

The automatic storage mainly includes the stacker crane 10 and a rack apparatus 12. The stacker crane 10 moves along the route 5 in the automatic storage 1. The stacker crane 10 conveys articles W placed on a pallet P and places the articles W onto the rack apparatus 12. The rack apparatus 12 is arranged on each side of the stacker crane 10. The stacker crane 10 includes a traveling vehicle 10a, a mast 10b standing on the traveling vehicle 10a, a platform 10c supported by the mast 10b in a vertically movable manner, and a fork 10d that performs transferring, which moves towards and away from the platform 10c. The traveling vehicle 10a is guided by a pair of guide rails 11a arranged vertically along the route 5.

The rack apparatus 12 of the first preferred embodiment of the present invention is for storing articles W. The rack apparatus 12 includes a rack apparatus body 14 (an example of the main body portion) and a plurality of shelves 16 arranged in the rack apparatus body 14.

The rack apparatus body 14 includes a plurality of support posts 21, a plurality of braces 23, and a plurality of horizontal members 24. The plurality of support posts 21 are arranged on a floor FL. Here, the support posts 21 arranged closer to the stacker crane 10 are referred to as first support posts 21a. Further, the support posts 21 arranged apart from the stacker crane 10 are referred to as second support posts 21b. The first support posts 21a are arranged in the route direction. In addition, the second support posts 21b are arranged in the route direction. In addition, the first support posts 21a and the second support posts 21b are arranged so that each of the former and each of the latter correspond to each other in the direction perpendicular or substantially perpendicular to the route 5.

The brace 23 includes horizontal braces 23a, rear braces 23b, and side braces 23c. The horizontal braces 23a are arranged in a zigzag shape and connect the first support posts 21a with the second support posts 21b in the horizontal direction. The rear braces 23b connect neighboring second support posts 21b in the vertical direction. The side braces 23c are arranged in a zigzag shape and connect the first support post 21a with the second support post 21b in the vertical direction. The horizontal members 24 includes first horizontal members 24a connecting the first support posts 21a in the horizontal direction and second horizontal members 24b connecting the second support posts 21b. The horizontal members 24 are vertically arranged, with spaces in between, for the plurality of shelves 16.

The shelves 16 are portions on which the articles W are placed. The shelves 16 are arranged between the first support post 21a and the second support post 21b. Here, the plurality of shelves 16 are attached to the first support post 21a and the second support post 21b with spaces in between in a height direction.

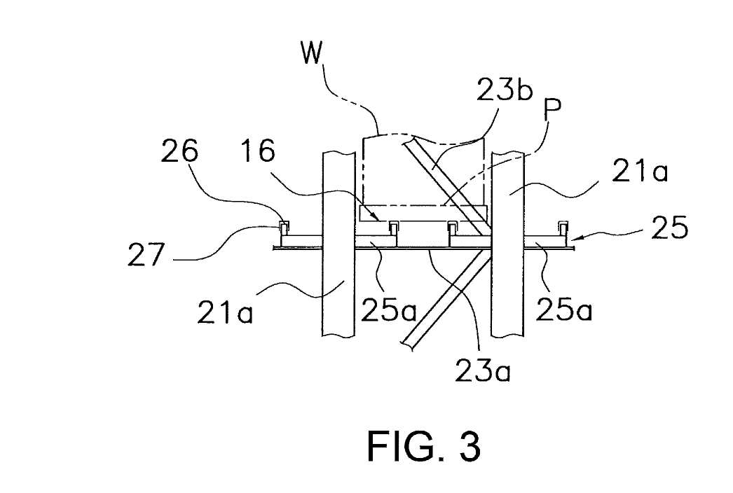

The shelves 16 include a pair of support members 25 secured to the support posts 21 and a base member 26 supported by the support member 25 in a cantilever manner as illustrated in FIGS. 2, 3, 4 and 5. The shelves 16 further include a placement member 27 on which the articles W are placed, and a height changing mechanism 28 that changes a height of the placement member 27. The placement member 27 is attached to the base member 26 in a way so as to be able to move relative to the base member. The height changing mechanism 28 changes the height of the placement member 27 relative to the base member 26 when the placement member 27 moves relative to the base member 26 in the back and forth direction (an example of a first horizontal direction) perpendicular or substantially perpendicular to the route 5.

Each of the pair of support members 25 is elongated in the travel direction. Here, the pair of support members 25 are secured to the first support post 21a and the second support post 21b so as to be parallel or substantially parallel to each other. Specifically, one of the pair of support members 25 (first support member 25a) is secured to the first support post 21a, and the other of the pair of support members 25 (second support member 25b) is secured to the second support post 21b.

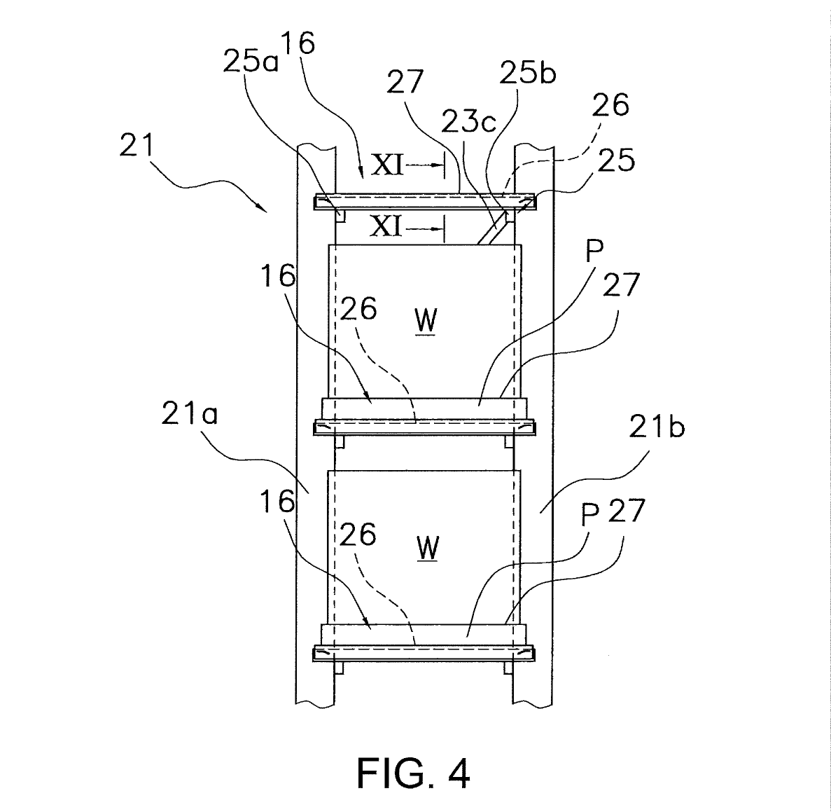

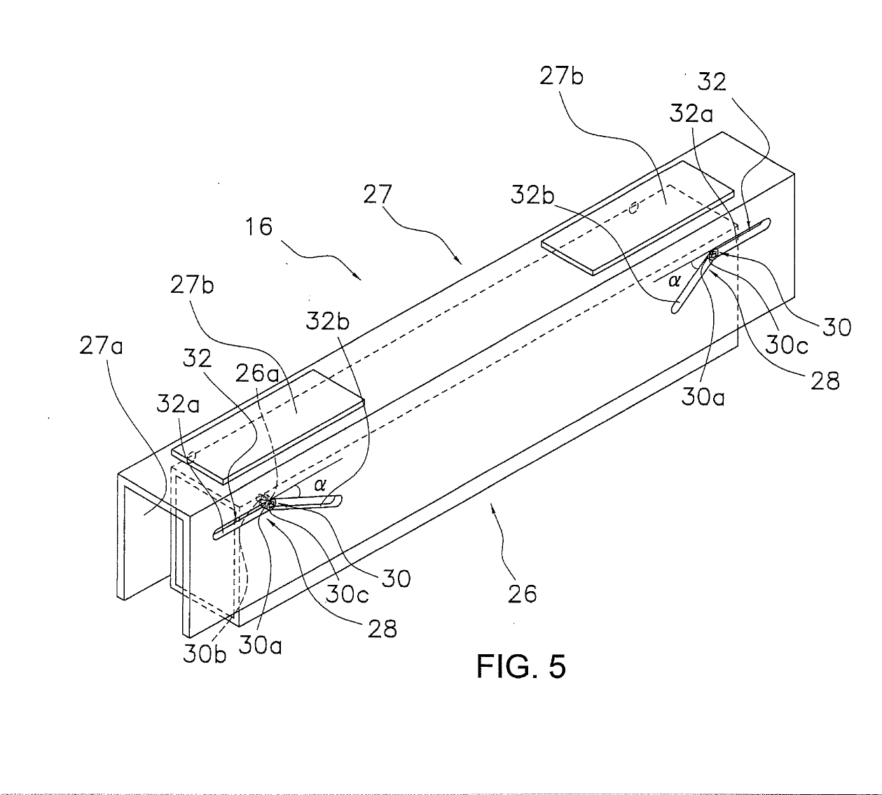

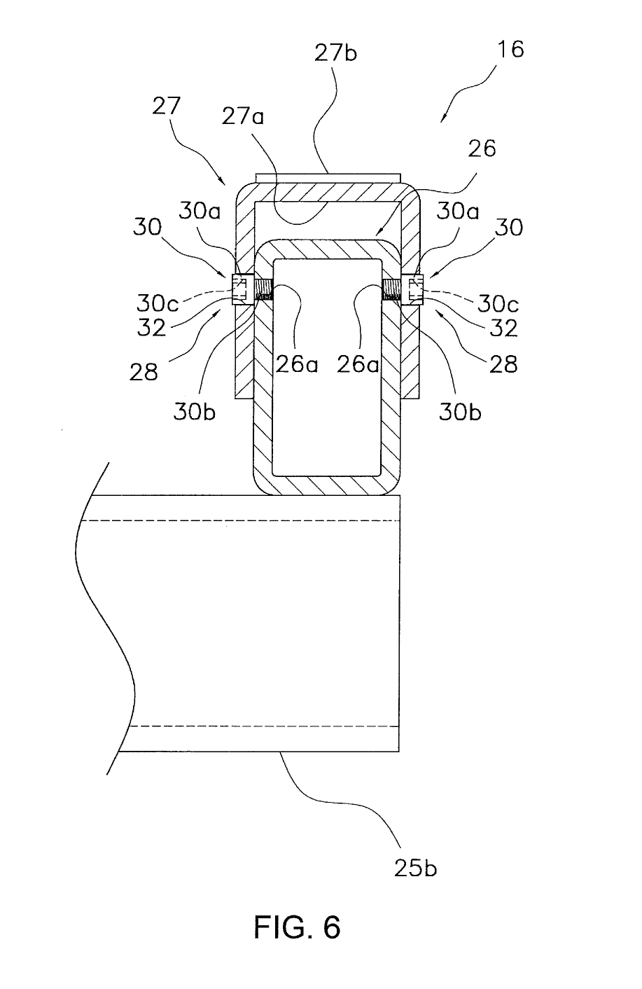

As illustrated in FIG. 6, the base member 26 is made of a square pipe, for example, and is secured to upper surfaces of distal ends of the first support member 25a and the second support member 25b. As illustrated in FIGS. 4 and 5, the base member 26 extends in the back and forth direction (an example of the first horizontal direction).

The placement member 27 is attached to the base member 26 in a way so as to be able to move relative to the base member 26. As illustrated in FIG. 6, the placement member 27 has a C-shaped or substantially C-shaped cross section and is elongated in the back and forth direction. The placement member 27 includes a concave portion 27a extending in the back and forth direction. The base member 26 is arranged in the concave portion 27a with a gap to the placement member 27 in the height direction. As illustrated in FIGS. 5 and 6, on the upper surface of the placement member 27, placement surfaces 27b are arranged with a space in between in the back and forth direction, on which the pallet P is placed. The placement surfaces 27b preferably are made of synthetic resin, for example, and are arranged to prevent skid.

The height changing mechanism 28 includes two pins 30 arranged on two sides of the base member 26, and two slits 32 arranged on two sides of the placement member 27. The two pins 30 are arranged on the right and left sides of the base member 26 at each end in the back and forth direction. The two slits 32 are arranged so as to be capable of engaging with the pins 30 on the right and left sides of the placement member 27. The pins 30 are screw members, for example, which are screwed into thread holes 26a located on the right and left sides of the base member 26 at each end. The pin 30 includes a head portion 30a that engages with the slit 32 and a threaded portion 30b having a smaller diameter than the head portion 30a. The head portion 30a is provided with a hex socket 30c to engage with a hexagon wrench, for example. After the placement member 27 is set to hang above the base member 26, the pin 30 passes through the slit 32, is screwed into the thread hole 26a, and is secured to the base member 26.

The slits 32 are formed in a symmetrical manner with respect to a center line in the back and forth direction of the placement member 27. The slit 32 has a width that enables the pin 30 to enter. The slit 32 includes a first portion 32a extending in the back and forth direction and a second portion 32b extending obliquely inward and downward from the first portion 32a. Each of the first portion 32a and the second portion 32b extends linearly. An angle α between the horizontal first portion 32a and the second portion 32b extending obliquely downward is preferably between about 20 degrees and about 25 degrees, for example. It is because, with the angle α in this range, kinetic energy caused by side sway at about 0.3 G to about 0.5 G can be effectively absorbed as potential energy.

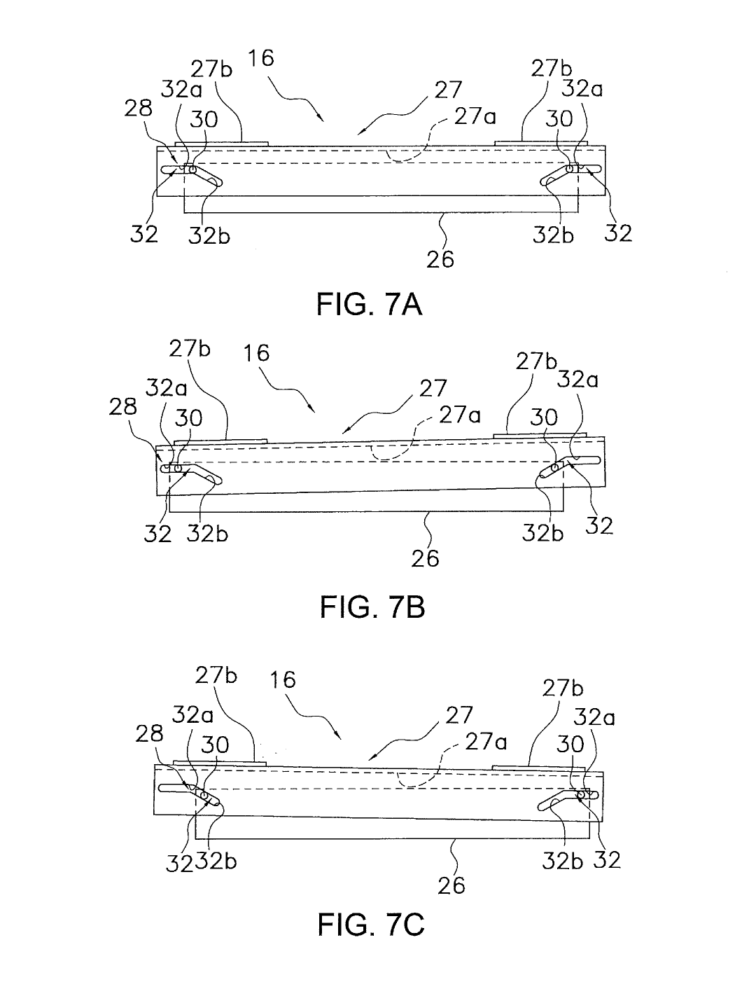

In the rack apparatus 12 having this structure, when the floor FL sways due to an earthquake or the like so that the sway is transmitted to the shelves 16 via the rack apparatus body 14, a force of the sway in the back and forth direction causes the pallet P and the articles W to move. However, the placement member 27 including the placement surfaces 27b sways in the back and forth direction and in the up and down direction from an initial position illustrated in FIG. 7A to a first slanting position illustrated in FIG. 7B or a second slanting position illustrated in FIG. 7C with respect to the base member 26. In this case, one end and the other end of the placement member 27 sway alternately in the up and down direction. Thus, kinetic energy due to the sway is converted into potential energy and is attenuated. In addition, friction between the pin 30 and the slit 32 acts to further attenuate the kinetic energy. As a result, when the articles W are placed on the pallet P, the articles W hardly move on the pallet P so that the articles W hardly fall. In addition, since movement of the articles W is suppressed without using a stopper or the like, the articles W are not damaged. Further, when the sway of the rack apparatus 12 stops, the placement member 27 returns to the initial position by its weight. Still further, since of the sway in the up and down direction, even if inertia acts in the right and left direction, the articles W hardly drop from the placement member 27.

Hereinafter, a first variation and a second variation of the first preferred embodiment of the present invention are described in which the slit extends obliquely downward toward the other slit.

### First Variation of First Preferred Embodiment

In the first preferred embodiment, the slit 32 of the height changing mechanism 28 preferably includes the horizontal first portion 32a and the second portion 32b extending obliquely downward. Note that description of the same member as in the first preferred embodiment is omitted in the following description.

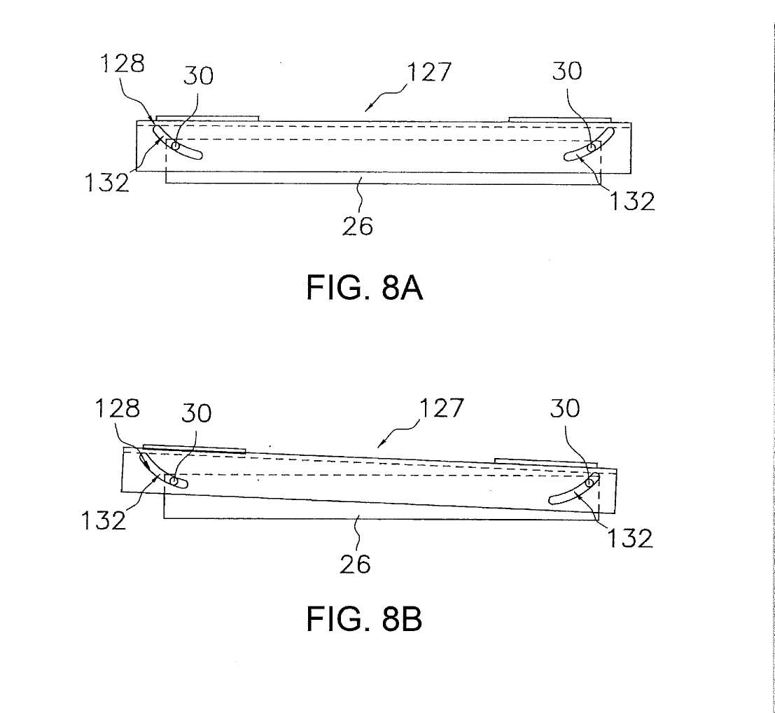

In the first variation, as illustrated in FIG. 8A, a slit 132 of a height changing mechanism 128 extends inward and downward like a downwardly convex arc. A difference between heights of the two ends of the slit 132 is larger than that in the preferred embodiment described above. Thus, when a placement member 127 sways from an initial position in the back and forth direction illustrated in FIG. 8A to a first slanting position illustrated in FIG. 8B or a second slanting position (not shown), an ascended position of one end or the other end of the placement member 127 becomes higher than that in the first preferred embodiment, so that larger potential energy can be obtained.

### Second Variation of First Preferred Embodiment

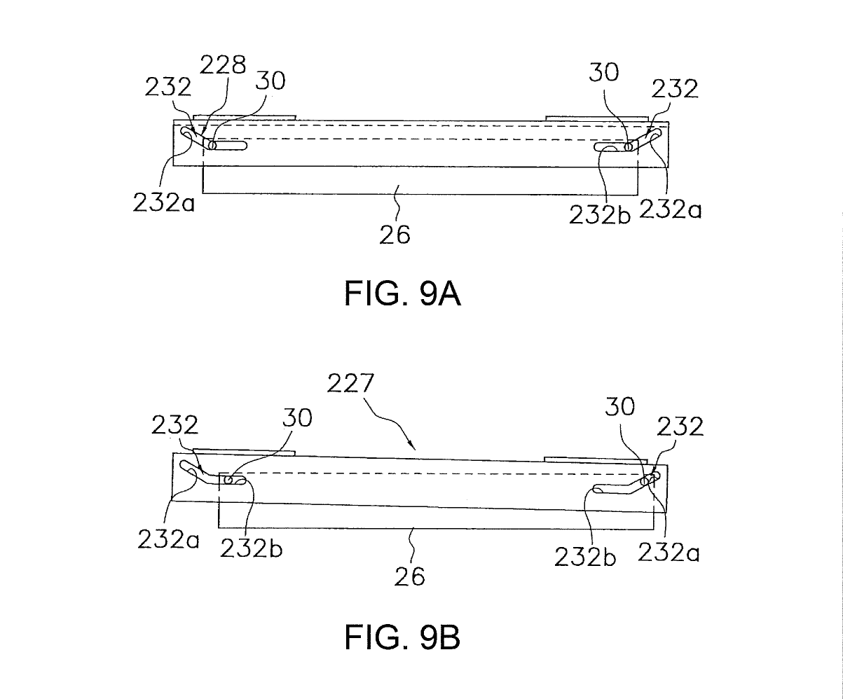

In the second variation, as illustrated in FIG. 9A, a first slit 232a of a slit 232 of a height changing mechanism 228 extends inward and downward obliquely. A second slit 232b extends in the back and forth direction. Thus, when a placement member 227 sways from an initial position in the back and forth direction illustrated in FIG. 9A to a first slanting position illustrated in FIG. 9B or a second slanting position (not shown), one end or the other end of the placement member 227 sways alternately in the up and down direction. Thus, the same action and effect as described above is obtained.

### Second Preferred Embodiment

In the second preferred embodiment, a preferred embodiment is described where the slit is preferably V-shaped or substantially V-shaped including a first portion and a second portion.

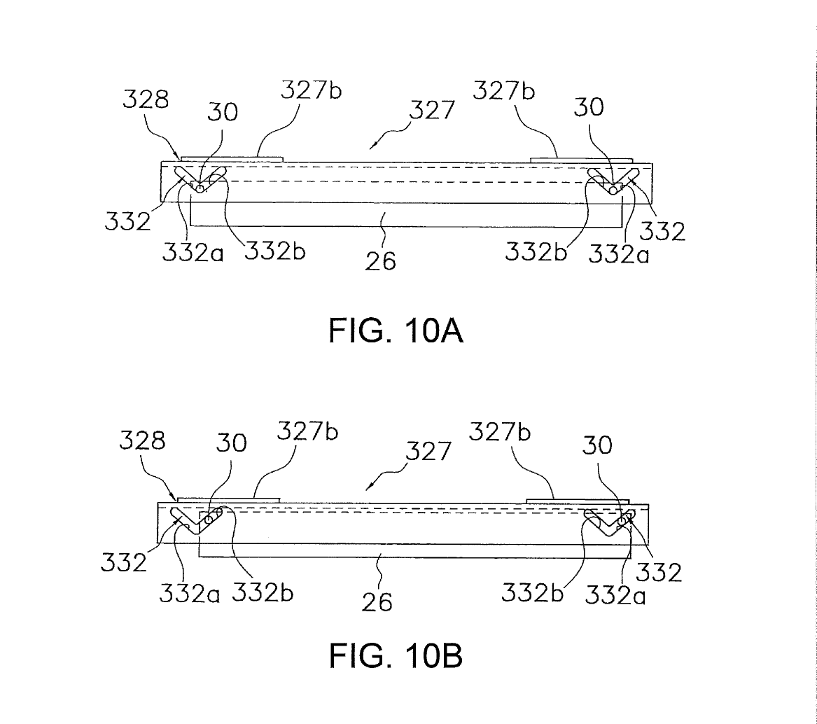

As illustrated in FIG. 10A, in the second preferred embodiment, when a placement member 327 sways sideways in the back and forth direction, a height changing mechanism 328 sways from an initial position toward a first horizontal position illustrated in FIG. 10B and a second horizontal position (not shown) in the up and down direction and in the back and forth direction with respect to the base member 26. Therefore, slits 332 arranged at the two ends of the placement member 327 have the same shape in the second preferred embodiment. In addition, a first portion 332a and a second portion 332b have a line-symmetric shape. The first portion 332a of the slit 332 linearly extends inward and downward. The second portion 332b linearly extends inward and upward from the lower end of the first portion 332a. Therefore, the slit 332 is preferably V-shaped or substantially V-shaped. In a height changing mechanism 338 structured in this way, the first horizontal position and the second horizontal position are arranged at the same height in response to a displacement from the initial position in the back and forth direction.

In this second preferred embodiment, when the placement member 327 sways back and forth relative to a base member 326, the placement member 327 sways up and down while maintaining the horizontal state. In this way, kinetic energy is decreased, and the articles W hardly fall when the articles W are placed on the pallet P.

Here, since a placement surface 327b sways in the horizontal state, the articles W hardly move in the back and forth direction when the articles W are placed on the pallet P. In addition, when the sway subsides, the placement member 327 returns to the initial position.

### Variation of Second Preferred Embodiment

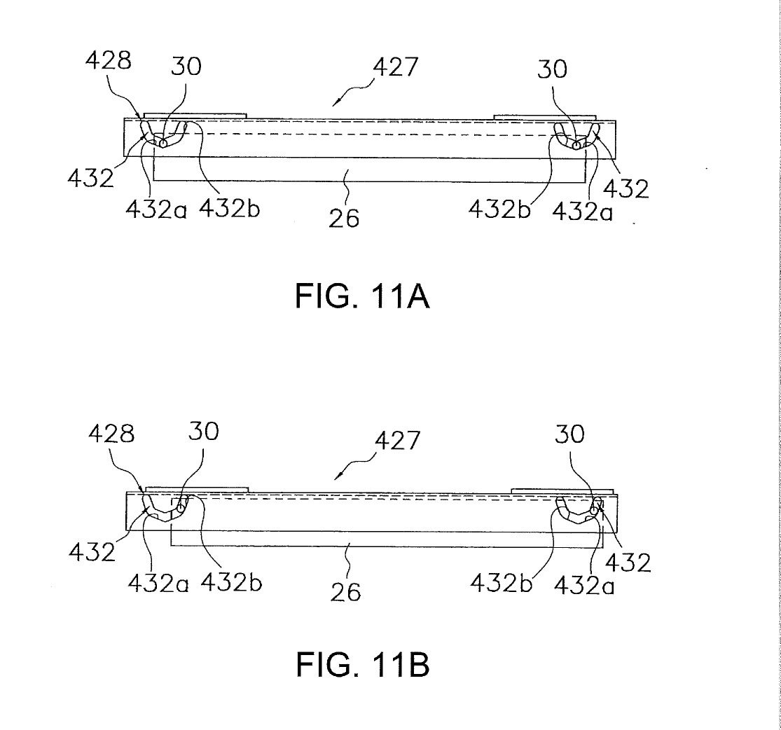

As illustrated in FIGS. 11A and 11B, in a variation of the second preferred embodiment, a slit 432 of a height changing mechanism 428 preferably is V-shaped or substantially V-shaped including a first portion 432a and a second portion 432b. The first portion 432a and the second portion 432b have an inclination that changes midway. In other words, the first portion 432a and the second portion 432b each preferably include a first linear portion and a second linear portion connected to the upper end of the first linear portion, and an inclination angle, relative to the horizontal direction, of the second linear portion is larger than that of the first linear portion.

In the variation of the second preferred embodiment having the structure described above, when the placement member 427 moves in the back and forth direction, acceleration of the sway in the up and down direction changes on the way of the movement. Therefore, kinetic energy is attenuated more efficiently.

The characteristics and advantageous effects of preferred embodiments described above are explained in more detail below. Note that in the following description, among numerals denoting each member, only the first-mentioned numerals are used.

The automatic storage rack apparatus 12 is arranged along the route 5 for the stacker crane 10. The automatic storage rack apparatus 12 includes the rack apparatus body 14, and the plurality of shelves 16 provided in the rack apparatus body 14. At least one of the shelves 16 includes the base member 26 fixed to the rack apparatus body 14, the placement member 27, and the height changing mechanism 28. The placement member 27 is preferably arranged for an article to be placed thereon. The placement member 27 is attached to the base member 26 such that the placement member 27 is movable relative to the base member 26. The height changing mechanism 28 is configured to change a height of the placement member 27 relative to the base member 26 when the placement member 27 moves relative to the base member 26 in a horizontal direction.

In this rack apparatus 12, when the rack apparatus 12 sways sideways and the placement member 27, on which the articles W are placed, moves horizontally relative to the base member 26 by an external force of the side sway, the height of the placement member 27 relative to the base member 26 is changed. Thus, kinetic energy (external force) that moves the placement member 27 horizontally is converted into potential energy so that only a portion of the external force acts on the articles W. Therefore, even if the rack apparatus 12 sways sideways, a movement amount of the articles W is reduced. As a result, the articles W hardly fall.

The height changing mechanism 28 preferably is configured to change the height of the placement member 27 relative to the base member 26 when the placement member 27 moves relative to the base member 26 in the back and forth direction perpendicular or substantially perpendicular to the route 5. Thus, the articles W hardly fall to the route side on which the stacker crane 10 is positioned.

The height changing mechanism 28 may cause the heights of the two ends of the placement member 27 in the back and forth direction to differ from each other. Thus, since the heights of two ends of the placement member 27 in the back and forth direction are changed when the placement member 27 moves in the back and forth direction, the placement member 27 easily returns to the position before movement.

The base member 26 and the placement member 27 may be elongated in the back and forth direction. The placement member 27 is formed with the concave portion 27a extending in the back and forth direction. The base member 26 is provided in the concave portion 27a and defines a gap in between in the height direction. Thus, even if the height changing mechanism 28 is arranged between the base member 26 and the placement member 27, the entire height is reduced.

The height changing mechanism 28 may include the two pins 30 provided at each of the two ends of the base member 26 in the back and forth direction, and the two slits 32 located at each of the two ends of the placement member 27 in the back and forth direction and into which the two pins 30 are inserted, respectively. Thus, the height changing mechanism 28 is inexpensive.

Each of the slits 32 may include the first portion 32a extending in the back and forth direction and the second portion 32b extending inward and downward from the first portion 32a. Thus, the height is changed by a simple shape of the slit 32.

### Other Preferred Embodiments

Although preferred embodiments of the present invention are described above, the present invention is not limited to these preferred embodiments and can be variously modified within the scope without deviating from the spirit of the present invention. In particular, the plurality of preferred embodiments and variations described in this specification can be arbitrarily combined.

The base member 26 is preferably made of a square pipe in the preferred embodiment described above, but the present invention is not limited to this. The base member may have any shape and may be, for example, a normal round pipe.

The fixed pin is preferably engaged with the slit in the preferred embodiment described above, but the present invention is not limited to this. Instead of the pin, a rotatable threaded roller such as a cam follower may be screwed into the thread hole 26a. In this case, attenuation amount of the kinetic energy due to friction of the pin is decreased, but attenuation amount due to potential energy is increased.

The four pins are fixed to the side surfaces of the base member 26 preferably with screws in the preferred embodiment described above, but the present invention is not limited to this. For instance, after disposing the placement member to hang, it is possible to penetrate both ends of the base member by two pins from one side surface to the other side surface of the base member so that two ends of the pin protrude from both side surfaces. The pin may be prevented from dropping by a shaft retaining ring, for example.

The slit shape is not limited to that of the preferred embodiments, and it is possible to adopt various variations.

The rack apparatus 12 that stores the articles W placed on the pallets P is described as an example in the preferred embodiments above, but the present invention is not limited to this. The present invention can be also applied to a rack apparatus that directly stores articles on shelves.

The placement member 27 is preferably provided with the concave portion 27a in the preferred embodiment described above, but the present invention is not limited to this. For instance, it is possible to provide a concave portion in the base member and to place the placement member in the concave portion. In this case, the shelves 16 of the first preferred embodiment illustrated in FIG. 6 is inverted upside down, the base member 26 having a square pipe shape is used as a placement member, and the placement member 27 having a C-shaped cross section is used as a base member.

Preferred embodiments of the present invention and variations thereof can be widely applied to a automatic storage rack apparatus.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-11. (canceled)

12. An automatic storage rack arranged along a route for a stacker crane, the automatic storage rack comprising:
a main body; and
a plurality of shelves provided in the main body; wherein
at least one of the shelves includes:
a base member fixed to the main body;
a placement member arranged to have an article placed thereon, the placement member being attached to the base member such that the placement member is movable relative to the base member; and
a height changing mechanism configured to change a height of the placement member relative to the base member when the placement member moves in a horizontal direction relative to the base member; wherein
the height changing mechanism is configured to change the height of the placement member relative to the base member when the placement member moves, relative to the base member, in a first horizontal direction perpendicular or substantially perpendicular to the route for the stacker crane.

13. The automatic storage rack according to claim 12, wherein the height changing mechanism is configured to cause heights of two ends of the placement member in the first horizontal direction to be different from each other.

14. The automatic storage rack according to claim 13, wherein
the base member and the placement member extend in the first horizontal direction;
one of the base member and the placement member includes a concave portion extending in the first horizontal direction; and
the other of the base member and the placement member is provided in the concave portion and separated from the concave portion by a gap in a height direction.

15. The automatic storage rack according to claim 14, wherein the height changing mechanism includes two pins provided respectively at two ends of the base member in the first horizontal direction, and two slits located respectively at two ends of the placement member in the first horizontal direction and into which the two pins are inserted, respectively.

16. The automatic storage rack according to claim 15, wherein each of the slits includes a first portion extending in the first horizontal direction and a second portion extending obliquely relative to the inward downward toward the other slit from the first portion.

17. The automatic storage rack according to claim 15, wherein each of the slits extends obliquely downward toward the other slit.

18. The automatic storage rack according to claim 17, wherein each of the slits has a shape of an arc projecting downward.

19. The automatic storage rack according to claim 17, wherein each of the slits includes a first portion extending obliquely downward toward the other slit and a second portion extending in a horizontal direction from the first portion.

20. The automatic storage rack according to claim 15, wherein each of the slits is V-shaped or substantially V-shaped and includes a first portion and a second portion.

21. The automatic storage rack according to claim 20, wherein the first portion and the second portion each have a straight line shape.

22. The automatic storage rack according to claim 20, wherein
each of the first portion and the second portion includes a first straight portion and a second straight portion connected to an upper end of the first straight portion; and
an angle of the second straight portion relative to the first horizontal direction is larger than an angle of the first straight portion relative to the first horizontal direction.
